(19) United States
(12) Patent Application Publication
(10) Pub. No.: US 2009/0143526 A1
(43) Pub. Date: Jun. 4, 2009

(54) COATING COMPOSITION AND COATED ARTICLE

(75) Inventor: Yuji HIROSE, Kanagawa (JP)

Correspondence Address: KRATZ, QUINTOS & HANSON, LLP, 1420 K Street, N.W., Suite 400, WASHINGTON, DC, 20005, US

(73) Assignee: KANSAI PAINT CO., LTD., Amagasaki-shi (JP)

(21) Appl. No.: 12/276,867

(22) Filed: Nov. 24, 2008

(30) Foreign Application Priority Data
Nov. 29, 2007 (JP) 2007-308634

(51) Int. Cl. C08L 71/10; C08L 63/02

(52) U.S. Cl. 524/611; 525/523

(57) ABSTRACT

The present invention relates to a coating composition that can form a coating film with excellent oxygen barrier properties. An object of the invention is to provide a coated article having excellent corrosion resistance using the coating composition.

The present invention provides a coating composition comprising: a modified epoxy resin (A) containing a benzene diether structure represented by a specific formula (1), which is obtained by reacting diglycidyl ether (a1) with at least one phenol (a2) selected from resorcinol, hydroquinone, and catechol; and a crosslinking agent (B).

### TECHNICAL FIELD

The present invention relates to a coating composition that can form a coating film having excellent oxygen barrier properties. The present invention further relates to a coated article having excellent corrosion resistance, which is produced using the coating composition.

### BACKGROUND ART

Among coating compositions, cationic electrodeposition coating compositions are particularly excellent in terms of coating workability, and are capable of forming a coating film with excellent corrosion resistance. Therefore, cationic electrodeposition coating compositions have been widely used as undercoating compositions for conductive metal products requiring the above properties, such as automobile bodies.

To improve the safety of automobiles during collisions, the tubular portions, etc. of recent automobile bodies often have structures in which reinforcing members overlap each other. When electrodeposition coating is carried out, the current density of such portions becomes low, which makes it difficult to form an electrodeposition coating film; accordingly, only a thin film is formed thereon, or such portions remain uncoated. Furthermore, with such a structure, corrosion products (e.g., water, salts) easily accumulate, thus accelerating corrosion and reducing the strength of the automobile.

Improved corrosion resistance, particularly resistance to corrosion from exposure, has thus become an important object to be achieved. However, if the amount of plasticizer in the coating composition is reduced to improve the corrosion resistance of a cationic electrodeposition coating composition, the obtained coating film becomes too hard, and the coating composition may be unsatisfactory in terms of film thickness retention over time, electrodeposition coatability on alloyed hot-dip galvanized steel plates, the finish, etc.

Patent Document 1 discloses a gas barrier cationic electrodeposition coating composition comprising: a blocked isocyanate; and a polyamine resin composition obtained by reacting a specific epoxy resin with an amine compound containing an active hydrogen, the epoxy resin having a glycidyl ether moiety derived from resorcinol or a glycidylamine moiety derived from m-xylenediamine, the coating film formed after curing the resin composition containing at least 30 wt. % of “a specific skeletal structure containing an aromatic ring and nitrogen”.

The gas barrier cationic electrodeposition coating resin composition of Patent Document 1 has excellent corrosion resistance, and particularly excellent resistance to corrosion from exposure. These properties are achieved by “a specific skeletal structure containing an aromatic ring and nitrogen in the coating film” formed after curing the resin composition. However, the gas barrier cationic electrodeposition coating resin composition is insufficient in terms of electrodeposition coatability on alloyed hot-dip galvanized steel plates. Patent Document 1: Japanese Unexamined Patent Publication No. 2004-59866

### DISCLOSURE OF THE INVENTION

### Problem to be Solved by the Invention

An object of the present invention is to provide a coating composition that can form a coating film having excellent oxygen barrier properties.

Another object of the invention is to provide a coated article produced by applying the coating composition as a cationic electrodeposition coating composition, the coated article having excellent corrosion resistance, particularly excellent resistance to corrosion from exposure, excellent electrodeposition coatability on alloyed hot-dip galvanized steel plates, and an excellent finish.

### Means for Solving the Problem

As a result of extensive research to achieve the above objects, the present inventors found that a coating composition comprising: a modified epoxy resin (A) containing a benzene diether structure, which is obtained by reacting diglycidyl ether (a1) with at least one phenol (a2) selected from resorcinol, hydroquinone, and catechol; and a crosslinking agent (B) can form a coating film having excellent oxygen barrier properties. The inventors have accomplished the present invention based on this finding.

The present invention provides the following coating compositions and coated articles.
Item 1. A coating composition comprising a modified epoxy resin (A) and a crosslinking agent (B), wherein said modified epoxy resin (A) contains a benzene diether structure represented by Formula (1)

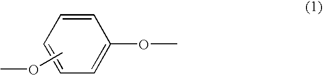

which resin is obtained by reacting diglycidyl ether (a1) with at least one phenol (a2) selected from resorcinol, hydroquinone, and catechol.
Item 2. A coating composition according to Item 1 wherein the modified epoxy resin (A) is an amino-group-containing modified epoxy resin (Al) containing an amino-group-containing compound.
Item 3. A coating composition according to Item 1 or 2 wherein the crosslinking agent (B) is a compound containing a m-xylylene structure in the molecule.
Item 4. A coating composition according to any one of Items 1 to 3 comprising 0.1 to 100 parts by mass of a layered pigment (C) per 100 parts by mass of the total of the modified epoxy resin (A) and crosslinking agent (B) on a solids basis.
Item 5. A coating composition according to any one of Items 1 to 4 which is a cationic electrodeposition coating composition.
Item 6. A coated article produced by applying the coating composition of any one of Items 1 to 5.

### EFFECT OF THE INVENTION

The coating film formed using the coating composition of the invention has excellent corrosion resistance, and particularly excellent resistance to corrosion from exposure. When the coating composition is used as a cationic electrodeposition coating composition, a coated article having excellent electrodeposition coatability (pinhole resistance) on alloyed hot-dip galvanized steel plates and an excellent finish can be provided.

The coating film formed using the coating composition of the invention is excellent in inhibiting the permeation of corrosion products (e.g., water, oxygen ion, chlorine ion) and is thus effective for enhancing corrosion resistance, particularly resistance to corrosion from exposure.

More specifically, compared to conventional bisphenol A type epoxy resins, the modified epoxy resin (A) that has at least one member selected from resorcinol, hydroquinone, and catechol as a phenol (a2) has a more flexible and denser molecular structure, can be easily produced, and is excellent in coating stability. Therefore, a coated article with an excellent finish can be provided over time.

Among the modified epoxy resins (A), amino-containing modified epoxy resins (A1) have a narrow molecular weight distribution, and amino groups dispersible in water are localized at the molecular ends of the resins. Therefore, amino-containing modified epoxy resins (A1) achieve excellent performance even with a small amount of neutralizer (high water dispersibility even with a small amount of neutralizer and good emulsion stability after being dispersed in water), and can form a coating film with excellent electrodeposition coatability (pinhole resistance) on alloyed galvanized hot-dip steel plates.

### BEST MODE FOR CARRYING OUT THE INVENTION

A feature of the coating composition of the present invention is that the composition contains a modified epoxy resin (A) and a crosslinking agent (B) as resin components. The details are described below.

### Modified Epoxy Resin (A)

The modified epoxy resin (A) contains a benzene diether structure represented by Formula (1)

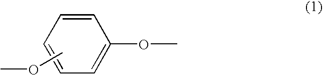

and the structure is obtained by reacting diglycidyl ether (a1) with at least one phenol (a2) selected from resorcinol, hydroquinone, and catechol.
Diglycidyl Ether (a1):

Diglycidyl ether (a1) is a compound containing two epoxy groups in one molecule, and is obtained by reacting a difunctional phenolic compound with epichlorohydrin.

The difunctional phenolic compound may be a known compound. Examples of such polyphenol compounds include bis(4-hydroxyphenyl)-2,2-propane[bisphenol A], 4,4-dihydroxybenzophenone, bis(4-hydroxyphenyl)methane [bisphenol F], bis(4-hydroxyphenyl)-1,1-ethane, bis(4-hydroxyphenyl)-1,1-isobutane, bis(4-hydroxy-tert-butylphenyl)-2,2-propane, bis(2-hydroxynaphthyl)methane, tetra(4-hydroxyphenyl)-1,1,2,2-ethane, and 4,4-dihydroxydiphenylsulfone (bisphenol S), and the like.

Bisphenol-type epoxy resins, particularly bisphenol A-derived epoxy resins represented by Formula (2) below, are particularly preferable as the epoxy resin obtained by reacting a difunctional phenolic compound with epichlorohydrin, from the viewpoint of long-term corrosion resistance, such as exposure resistance.

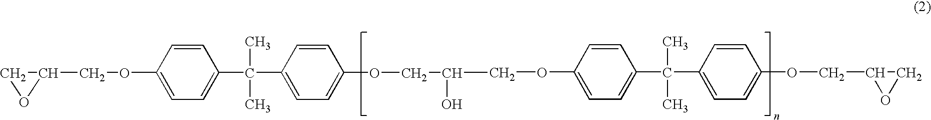

In Formula (2), n is preferably an integer of 0 to 2.

The epoxy resin usually has a number average molecular weight (Note 1) of 400 to 100,000, preferably 600 to 60,000, and even more preferably 800 to 20,000, and usually has an epoxy equivalent of 180 to 70,000, preferably 240 to 40,000, and more preferably 300 to 15,000. Examples of commercially available products of such epoxy resins include resins sold by Japan Epoxy Resin Co., Ltd. under the trade names of jER828EL, jER1002, jER1004, and jER1007.
(Note 1) Number average molecular weight: measured in accordance with JIS K 0124-83 and determined from the calibration curve of standard polystyrene and chromatograms obtained using an RI refractometer from GPC performed at a temperature of 40° C. and a flow rate of 1.0 ml/min using four separation columns “TSK gel G 4000HXL”, “TSK gel G3000HXL”, “TSK gel G2500HXL”, and “TSK gel G2000 HXL” (products of TOSOH) and using tetrahydrofuran for GPC as an eluent.
   Phenol (a2):

Examples of phenols (a2) include hydroquinone, catechol, and resorcinol.

Phenols (a2) are compounds particularly effective for imparting satisfactory corrosion resistance, satisfactory electrodeposition coatability (pinhole resistance) on alloyed hot-dip galvanized steel plates, and a satisfactory finish. Among the coating properties, hydroquinone is preferable from the viewpoint of corrosion resistance, particularly resistance to corrosion from exposure. The above compounds can be used singly or in a combination of two or more.

The modified epoxy resin (A) can be produced by reacting diglycidyl ether (a1) and a phenol (a2), optionally with a polyphenol compound, in an appropriate amount of solvent, in the presence of a catalyst. Examples of such reaction catalysts include secondary amines such as diethylamine, dibutylamine, diethanolamine, dipropanolamine, and methylethanolamine; tertiary amines such as dimethylbenzylamine and tributylamine; and quaternary ammonium salts such as tetraethylammonium bromide and tetrabutylammonium bromide. The reaction temperature is 80 to 200° C., and preferably 90 to 180° C., and the reaction time is about 1 to about 6 hours, and preferably about 1 to about 5 hours.

The polyphenol compound may be a known compound. Examples of such polyphenol compounds include bis(4-hydroxyphenyl)-2,2-propane [bisphenol A], 4,4-dihydroxybenzophenone, bis(4-hydroxyphenyl)methane [bisphenol F], bis(4-hydroxyphenyl)-1,1-ethane, bis(4-hydroxyphenyl)-1,1-isobutane, bis(4-hydroxy-tert-butylphenyl)-2,2-propane, bis(2-hydroxynaphthyl)methane, tetra(4-hydroxyphenyl)-1,1,2,2-ethane, 4,4-dihydroxydiphenylsulfone (bisphenol S), phenol novolac, and cresol novolac.

Examples of solvents that can be used in the reaction include hydrocarbon solvents such as toluene, xylene, cyclohexane, and n-hexane; ester solvents such as methyl acetate, ethyl acetate, and butyl acetate; ketone solvents such as acetone, methyl ethyl ketone, methyl isobutyl ketone, and methyl amyl ketone; amide solvents such as dimethylformamide and dimethylacetamide; alcohol solvents such as methanol, ethanol, n-propanol, and iso-propanol; aromatic alkyl alcohols such as phenylcarbinol and methylphenylcarbinol; ether alcohol compounds such as ethylene glycol monobutyl ether and diethylene glycol monoethyl ether; and mixtures thereof.

From the viewpoint of corrosion resistance and electrodeposition coatability on alloyed galvanized steel plates, the mixing ratio of diglycidyl ether (a1) to phenol (a2) is preferably such that the amount of diglycidyl ether (a1) is 50 to 90 mass %, and preferably 60 to 85 mass %, and the amount of phenol (a2) is 10 to 50 mass %, and preferably 15 to 40 mass %, based on the total mass of these components, calculated as solids. Other polyphenol compounds may be optionally added can be used according to the desired coating properties. Thus, the obtained modified epoxy resin (A) has an epoxy equivalent of 500 to 3,000, and preferably 800 to 2,500.

### Amino-Group-Containing Modified Epoxy Resin (A1)

The modified epoxy resin (A) used in the coating composition of the invention may be an amino-group-containing modified epoxy resin (A1) containing an amino-group-containing compound (a3), which is preferably used as a resin component of cationic electrodeposition coating compositions.

The amino-group-containing compound (a3) is a component for imparting cationic properties to introduce an amino group to a modified epoxy resin. A compound having at least one active hydrogen capable of reacting with an epoxy group is used as the amino-group-containing compound (a3).

Examples of the amino-group-containing compound (a3) that can be used for this purpose include mono- or di-alkylamines such as monomethylamine, dimethylamine, monoethylamine, diethylamine, monoisopropylamine, diisopropylamine, triisopropylamine, monobutylamine and dibutylamine; alkanolamines such as monoethanolamine, diethanolamine, mono(2-hydroxypropyl)amine, di(2-hydroxypropyl)amine, tri(2-hydroxypropyl)amine, monomethylaminoethanol and monoethylaminoethanol; alkylenepolyamines such as ethylenediamine, propylenediamine, butylenediamine, hexamethylenediamine, tetraethylenepentamine, pentaethylenehexamine, diethylaminopropylamine, diethylenetriamine and triethylenetetramine; and ketimine compounds of these polyamines; alkyleneimines such as ethyleneimine and propyleneimine; and cyclic amines such as piperazine, morpholine and pyrazine.

To obtain satisfactory corrosion resistance and satisfactory electrodeposition coatability on alloyed hot-dip galvanized steel plates, the proportion of the amino-group-containing compound (a3) in the amino-group-containing modified epoxy resin (A1) is 10 to 50 mass %, and preferably 15 to 45 mass %, based on the total mass of the amino-group-containing modified epoxy resin (A1), calculated as solids.
Crosslinking agent (B):

The coating composition according to the present invention can be prepared using a crosslinking agent (B), such as a polyisocyanate compound, a blocked polyisocyanate compound, or an amino resin, with a modified epoxy resin (A), to produce a thermosetting coating composition.

The polyisocyanate compound used as the crosslinking agent (B) may be a known compound. Examples of such compounds include aromatic, aliphatic, or alicyclic polyisocyanate compounds, such as (o-, m-, p-)tolylene diisocyanate, (o-, m-, p-)xylylene diisocyanate, phenylene diisocyanate, diphenylmethane-2,2′-diisocyanate, diphenylmethane-2,4′-diisocyanate, diphenylmethane-4,4′-diisocyanate, crude MDI [polymethylene polyphenyl isocyanate], bis(isocyanatemethyl)cyclohexane, tetramethylene diisocyanate, hexamethylene diisocyanate, methylene diisocyanate, and isophorone diisocyanate; cyclopolymers or biuret compounds of these polyisocyanate compounds; and combinations thereof.

Among these, a xylylene diisocyanate compound, particularly an m-xylylene diisocyanate compound is preferably used as a compound of the coating composition to provide a coating film with enhanced oxygen barrier properties.

The blocked polyisocyanate compound is a product obtained by an addition reaction between a polyisocyanate compound and a blocking agent, and has blocked isocyanate groups. The blocked polyisocyanate compound is stable at room temperature. However, when the blocked polyisocyanate compound is heated to a baking temperature of the coating film (usually about 100 to about 200° C.), free isocyanate groups may be reformed by release of the blocking agent.

Examples of such blocking agents include oxime compounds such as methyl ethyl ketoxime and cyclohexanone oxime; phenolic compounds such as phenol, para-t-butylphenol and cresol; aliphatic alcohols such as n-butanol and 2-ethylhexanol; aromatic alkyl alcohols such as phenylcarbinol and methylphenylcarbinol; ether alcohol compounds such as ethylene glycol monobutyl ether and diethylene glycol monoethyl ether; lactam compounds such as ε-caprolactam and γ-butyrolactam; and the like.

Examples of amino resins include methylolated amino resins obtained by reacting an aldehyde with an amino component such as melamine, urea, benzoguanamine, acetoguanamine, steroguanamine, spiroguanamine, dicyandiamide, or the like.

Examples of aldehydes used in the reaction include formaldehyde, paraformaldehyde, acetaldehyde, benzaldehyde, and the like. Compounds obtained by etherifying a methylolated amino resin as mentioned above with an appropriate alcohol can also be used as amino resins. Examples of alcohols that can be used for etherification include methyl alcohol, ethyl alcohol, n-propyl alcohol, isopropyl alcohol, n-butyl alcohol, isobutyl alcohol, 2-ethylbutanol, and 2-ethylhexanol.

The mixing ratio of the modified epoxy resin (A) to the crosslinking agent (B) in the coating composition of the invention is such that the amount of modified epoxy resin (A) is usually 50 to 85 mass %, preferably 55 to 80 mass %, and even more preferably 55 to 78 mass %, and the amount of crosslinking agent (B) is usually 15 to 50 mass %, preferably 20 to 45 mass %, and more preferably 22 to 45 mass %, based on the total mass of these components, calculated as solids. The amount of xylylene diisocyanate compound is usually 0.1 to 30 mass %, preferably 1 to 20 mass %, and more preferably 5 to 15 mass %, based on 100 parts by mass of the total of the modified epoxy resin (A) and crosslinking agent (B), calculated as solids. The molar ratio of NCO groups derived from the crosslinking agent (B) to OH groups derived from the modified epoxy resin (A) is an NCO group/OH group ratio in the range of 0.7 to 1.1, and preferably 0.8 to 1.0.

The coating composition of the invention may contain, in addition to the modified epoxy resin (A) and the crosslinking agent (B), pigments such as color pigments, rust preventive pigments, and extender pigments. Such pigments can be dispersed as fine particles in a paste and incorporated as a pigment-dispersed paste into the coating composition.

Such a pigment-dispersed paste can be produced by adding and dispersing a resin for pigment dispersion, a neutralizer, and a pigment using a dispersion mixer, such as a ball mill, sand mill, and or pebble mill.

Examples of such pigments include color pigments such as titanium oxide, carbon black, and red iron oxide; extender pigments such as clay, mica, baryta, calcium carbonate, talc, and silica; rust preventive pigments such as aluminum phosphomolybdate, aluminium tripolyphosphate, and zinc oxide (zinc flower); and the like.

Among such extender pigments, the use of layered pigment (C) in a specific amount is particularly preferable to improve oxygen barrier properties. For example, at least one compound selected from montmorillonite, beidellite, nontronite, saponite, hectorite, stevensite, and bentonite may be used as the layered pigments (C). Such a layered pigment (C) functions as a barrier against corrosion-promoting substances (such as O₂, Cl⁻, Na⁺) in the coating film, and also retains corrosion promoting substances therein.

The coating composition preferably contains the layered pigment (C) in an amount of 1 to 100 parts by mass, and particularly 5 to 50 parts by mass, based on 100 parts by mass of the total of the modified epoxy resin (A) and crosslinking agent (B), calculated as solids.

The coating composition may contain a bismuth compound to inhibit corrosion and prevent rusting. Examples of bismuth compounds that can be used include bismuth oxide, bismuth hydroxide, basic bismuth carbonate, bismuth nitrate, bismuth silicate, organic acid bismuth, and the like. The coating composition may contain an organic tin compound, such as dibutyl tin dibenzoate, dioctyl tin oxide, or dibutyl tin oxide to improve the curability of the coating film. The resin for pigment dispersion may be a known compound, and examples thereof include hydroxyl group-containing resins containing hydroxyl groups and cationic groups, surfactants, and the like.

### Cationic Electrodeposition Coating Composition

The cationic electrodeposition coating composition containing an amino-group-containing modified epoxy resin (A1) as the modified epoxy resin (A) can be prepared in the following manner. Various additives such as surfactants and surface conditioners and an organic solvent are optionally added to the amino-group-containing modified epoxy resin (A1) and the crosslinking agent (B), and the mixture is fully mixed to prepare a resin composition. A water-soluble organic carboxylic acid or the like is then added to produce a water-soluble or water-dispersible emulsion of the resin composition.

In general, the resin composition can be neutralized with known acids. Acids such as acetic acid, formic acid, lactic acid, and mixtures thereof are particularly preferable. Subsequently, a paste for pigment dispersion is added to the emulsion, and water is added for adjustment to prepare a cationic electrodeposition coating composition.

The coating composition of the invention is preferably used for coated articles requiring corrosion resistance, particularly resistance to corrosion from exposure, and can be used as a corrosion protective coating composition that is applied by electrostatic coating, roll coating, electrodeposition coating, etc.

Examples of substrates to which the coating composition of the invention is applied include cold rolled steel sheets; alloyed hot-dip galvanized steel sheets; electrogalvanized steel sheets; electrolytic zinc-iron double-plated steel sheets; organic composite-plated steel sheets; aluminum materials; magnesium materials; and such metal sheets whose surface are further washed optionally by alkaline degreasing or like processes, and then surface-treated with phosphate or chromate.

In particular, the cationic electrodeposition coating composition containing an amino-group-containing modified epoxy resin (A1) and a crosslinking agent (B) has good corrosion resistance, and can provide a coated article with excellent electrodeposition coatability on alloyed hot-dip galvanized steel sheets, and an excellent finish. Therefore, the cationic electrodeposition coating composition can be used for any items made of metal, such as automobile bodies, two-wheeled vehicle parts, household appliances, and other instruments.

Cationic electrodeposition coating can be performed by preparing a bath of an electrocoating composition with a pH of 5.5 to 9.0 and a solids content of 5 to 40 wt. % achieved by dilution with deionized water or the like, and applying a current at a voltage of 100 to 400 V to the bath adjusted to a temperature in the range of 15° C. to 35° C. using a substrate to be coated as a cathode. After the electrodeposition coating, the coated substrate is fully washed with water, such as ultrafiltrate (UF filtrate), reverse osmosis permeate (RO water), industrial water, pure water, or the like to remove an excess of the cationic electrodeposition coating composition.

The thickness of the electrodeposition coating film, although not particularly limited, is usually in the range of 5 to 40 μm, and preferably 12 to 30 μm, when dried. The electrodeposition coating film is baked and dried by heating with a dryer, such as an electric hot air dryer or a gas hot air dryer, at a temperature on the coated surface of 110° C. to 200° C., and preferably 140° C. to 180° C., for 10 to 180 minutes, and preferably for 20 to 50 minutes. The coating film can be cured by baking and drying.

### EXAMPLES

Production Examples, Examples, and Comparative Examples are given below to illustrate the present invention in more detail. The present invention is not limited thereto. In the Examples, “parts” and “%” are expressed in mass.

### Preparation of Modified Epoxy Resin (A)

### Production Example 1

### Preparation of Modified Resin Solution No. 1 (For Examples)

840 parts of jER828EL (Note 2), 160 parts of hydroquinone, and 0.8 parts of tetrabutylammonium bromide were added to a flask having an internal volume of 2 liters and equipped with a thermometer, a reflux condenser, and a stirrer, and allowed to react at 160° C. until the reaction mixture achieved an epoxy equivalent of 650. Subsequently, 250 parts of ethylene glycol monobutyl ether was added, and the mixture was stirred at 120° C. for about 15 minutes to give a modified resin solution No. 1 with a resin solids content of 80%. The number average molecular weight (see Note 1) of the modified resin No. 1 was 1,300.

### Production Examples 2 to 4

### Preparation of Modified Resin Solutions Nos. 2 to 4 (For Examples)

Modified resin solutions Nos. 2 to 4 were prepared in the same manner as in Production Example 1, except for using the components and proportions thereof shown in Table 1.

### Comparative Production Example 1

### Preparation of Modified Resin No. 5 (for Comparative Examples)

A modified resin solution No. 5 was prepared in the same manner as in Production Example 1, except for using the components and proportions thereof shown in Table 1.

### Comparative Production Example 2

### Preparation of Modified Resin No. 6 (for Comparative Examples)

A modified resin solution No. 6 was prepared in the same manner as in Production Example 1 except for using the components and proportions thereof shown in Table 1. Due to an excessively high viscosity of the resin, it was impossible to use the modified resin solution No. 6 to produce a thermosetting solvent-type coating composition and a cationic electrodeposition coating composition.

TABLE 1

| | | | Production | Production | Production | Production | Comparative | Comparative |
|---|---|---|---|---|---|---|---|---|
| | | | Example 1 | Example 2 | Example 3 | Example 4 | Example 1 | Example 2 |
| Modified Resin Solution | | | No. 1 | No. 2 | No. 3 | No. 4 | No. 5 | No. 6 |
| Components | Diglycidyl | jER828EL | 840 | 840 | | | 730 | |
| and | ether (a1) | (Note 2) | | | | | | |
| proportions | | jER806 | | | 813 | 813 | | |
| thereof | | (Note 3) | | | | | | |
| | | EX201 | | | | | | 735 |
| | | (Note 4) | | | | | | |
| | Difunctional | Hydro- | 160 | | 187 | | | |
| | phenol (a2) | quinone | | | | | | |
| | | Resorcinol | | 160 | | 187 | | 265 |
| | Polyphenol | Bisphenol A | | | | | 730 | |
| | compound | | | | | | | |
| | Organic | Ethylene | 250 | 250 | 250 | 250 | 250 | 250 |
| | solvent | glycol | | | | | | |
| | | monobutyl | | | | | | |
| | | ether | | | | | | |

| | | | | | | | |
|---|---|---|---|---|---|---|---|
| Characteristic | Number average | 1600 | 1600 | 1600 | 2200 | 1600 | 5500 |
| values | molecular weight | | | | | | |
| | Solids | 80 | 80 | 80 | 80 | 80 | 80 |

With respect to the proportions of the components, the numerals are expressed in parts by mass.
(Note 2) jER828EL: trade name; a product of Japan Epoxy Resin Co., Ltd., bisphenol A diglycidyl ether, epoxy equivalent: 190, number average molecular weight: 380.
(Note 3) jER806: trade name; a product of Japan Epoxy Resin Co., Ltd., bisphenol F diglycidyl ether, epoxy equivalent: 165, number average molecular weight: 340.
(Note 4) EX201: trade name; a product of Nagase ChemteX Corporation, resorcinol diglycidyl ether, epoxy equivalent: 117, number average molecular weight: 235.

### Preparation of Amino-Group-Containing Modified Epoxy Resin (A1)

### Production Example 5

### Preparation of Amino-Group-Containing Epoxy Resin Solution No. 1 (for Examples)

1,250 parts of a modified resin solution No. 1 obtained in Production Example 1, 50 parts of ethylene glycol monobutyl ether, and 113 parts of diethanolamine, and 84 parts of a methyl isobutyl ketone-ketiminized product of diethylenetriamine were added to a flask having an internal volume of 2 liters and equipped with a thermometer, a reflux condenser, and an stirrer, and allowed to react at 120° C. for 4 hours to give an amine-added epoxy resin solution No. 1, i.e., an amino-group-containing modified epoxy resin with a resin solids content of 80%.

The resin solids of the amine-added epoxy resin solution No. 1 had an amine value of 80 mgKOH/g, and a number average molecular weight of about 1,700.

### Production Examples 6 to 8

### Preparation of Amino-Group-containing Epoxy Resin solutions Nos. 2 to 4

Amino-group-containing epoxy resin solutions Nos. 2 to 4 were prepared in the same manner as in Production Example 5 except for using the components and proportions thereof shown in Table 2.

TABLE 2

| | | Production | Production | Production | Production |
|---|---|---|---|---|---|
| | | Example 5 | Example 6 | Example 7 | Example 8 |
| Amino- | Amine-added epoxy resin | No. 1 | No. 2 | No. 3 | No. 4 |
| group- | Solution | | | | |
| containing | | | | | |
| modified | | | | | |
| resin solution | | | | | |
| (A1) | | | | | |
| Modified | Modified resin solution No. 1 | 1250 | | | |
| resin solution | (resin solids content: 80%) | | | | |
| (A) | Modified resin solution No. 2 | | 1250 | | |
| | (resin solids content: 80%) | | | | |
| | Modified resin solution No. 3 | | | 1250 | |
| | (resin solids content: 80%) | | | | |
| | Modified resin solution No. 4 | | | | 1250 |
| | (resin solids content: 80%) | | | | |
| Amino- | Diethanolamine | 113 | 113 | 113 | 113 |
| group- | Methyl isobutyl ketone- | 84 | 84 | 84 | 84 |
| containing | ketiminized product of | | | | |
| compound | diethylenetriamine | | | | |
| (a3) | | | | | |
| Solvent | Ethylene glycol monobutyl | 50 | 50 | 50 | 50 |
| | ether | | | | |
| Characteristic | Amine value (mgKOH/g) | 80 | 80 | 80 | 80 |
| values | Number average molecular | 1700 | 1700 | 1700 | 1700 |
| | weight | | | | |
| | Solids (%) | 80 | 80 | 80 | 80 |

With respect to the proportions of the components, the numerals are expressed in parts by mass (on a solids basis, except for solvents).

### Comparative Production Example 3

An amino-group-containing epoxy resin solution No. 5 was prepared in the same manner as in Production Example 5, except for using the components and proportions thereof shown in Table 3.

TABLE 3

| | | Comparative |
|---|---|---|
| | | Example 3 |
| Amino-group- | Amine-added epoxy resin solution | No. 5 |
| containing modified | | |
| resin solution (A1) | | |
| Modified resin | Modified resin solution No. 5 | 1250 |
| solution (A) | (resin solids content: 80%) | |
| Amino-group- | Diethanolamine | 113 |
| containing compound | Methyl isobutyl ketone-ketiminized | 84 |
| (a3) | product of diethylenetriamine | |
| Organic solvent | Ethylene glycol monobutyl ether | 50 |
| Characteristic values | Amine value (mgKOH/g) | 80 |
| | Number average molecular weight | 1700 |
| | Solids (%) | 80 |

With respect to the proportions of the components, the numerals are expressed in parts by mass (on a solids basis, except for solvents).

### Production Example 9

### Preparation of Crosslinking Agent No. 1

222 parts of isophorone diisocyanate and 44 parts of methyl isobutyl ketone were added to a reactor and heated to 50° C. After 174 parts of methylethylketoxime was slowly added, the mixture was heated to 60° C. While maintaining this temperature, sampling of the reaction mixture was performed over time to confirm that measurement of the infrared absorption spectrum recorded no further absorption of unreacted isocyanate. A crosslinking agent No. 1 with a resin solids content of 90% was thus obtained.

### Production Example 10

### Preparation of Crosslinking Agent No. 2

188 parts of m-xylylene diisocyanate and 40 parts of methyl isobutyl ketone were added to a reactor, and the mixture was heated to a temperature of 50° C. After 174 parts of methylethylketoxime was slowly added, the mixture was heated to 60° C. While maintaining this temperature, sampling of the reaction mixture was performed over time to confirm that measurement of the infrared absorption spectrum recorded no further absorption of unreacted isocyanate. A crosslinking agent No. 2 with a resin solids content of 90% was thus obtained.

### Production Example of Thermosetting Solvent-Type Coating Compositions

### Example 1

### Production of Thermosetting Coating Composition No. 1 (Example)

38 parts of a modified resin solution No. 1 with a solids content of 80% (30 parts on a resin solids basis) obtained in Production Example 1, 11 parts of titanium oxide, 1 part of carbon black, 40 parts of barium sulfate, 40 parts of calcium carbonate, 8 parts of zinc oxide, and 48 parts of xylene were added and mixed using a paint shaker for 1 hour to obtain a pigment dispersion. Further, 50 parts of a modified resin solution No. 1 with a solids content of 80% (40 parts on a resin solids basis), 33 parts of a crosslinking agent No. 1 obtained in Production Example 9 (30 parts on a solids basis), 130 parts of Solvesso #100 (Note 6), and 1 part of NEOSTANN U-100 (Note 7) were added to produce thermosetting coating composition No. 1.

### Examples 2 to 6

### Preparation of Thermosetting Coating Compositions Nos. 2 to 6 (Examples)

Thermosetting coating compositions Nos. 2 to 6 were prepared in the same manner as in Example 1, except for using the components and proportions thereof shown in Table 4.

### Comparative Example 1

### Preparation of Thermosetting Coating Composition No. 7 (Comparative Example)

A thermosetting coating composition No. 7 was prepared in the same manner as in Example 1, except for using the components and proportions thereof shown in Table 4.

TABLE 4

| | | | | | | | | Comparative |
|---|---|---|---|---|---|---|---|---|
| | | Example 1 | Example 2 | Example 3 | Example 4 | Example 5 | Example 6 | Example 1 |
| Thermosetting coating | | No. 1 | No. 2 | No. 3 | No. 4 | No. 5 | No. 6 | No. 7 |
| composition | | | | | | | | |
| Dispersed | Modified resin | 38 | | | | 38 | | |
| Resin | solution No. 1 | | | | | | | |
| | Modified resin | | 38 | | | | | |
| | solution No. 2 | | | | | | | |
| | Modified resin | | | 38 | | | 38 | |
| | solution No. 3 | | | | | | | |
| | Modified resin | | | | 38 | | | |
| | solution No. 4 | | | | | | | |
| | Modified resin | | | | | | | 38 |
| | solution No. 5 | | | | | | | |
| Pigment | Titanium oxide | 11 | 11 | 11 | 11 | 11 | 11 | 11 |
| | Carbon black | 1 | 1 | 1 | 1 | 1 | 1 | 1 |
| | Barium sulfate | 40 | 40 | 40 | 40 | 40 | 40 | 40 |
| | Calcium | 40 | 40 | 40 | 40 | 30 | 30 | 40 |
| | carbonate | | | | | | | |
| | BENTONE 38 (Note 5) | | | | | 10 | 10 | |
| | Zinc oxide | 8 | 8 | 8 | 8 | 8 | 8 | 8 |
| Solvent | Xylene | 48 | 48 | 48 | 48 | 62 | 62 | 48 |
| Resin | Modified resin | 50 | | | | 50 | | |
| | solution No. 1 | | | | | | | |
| | Modified resin | | 50 | | | | | |
| | solution No. 2 | | | | | | | |
| | Modified resin | | | 50 | | | 50 | |
| | solution No. 3 | | | | | | | |
| | Modified resin | | | | 50 | | | |
| | solution No. 4 | | | | | | | |
| | Modified resin | | | | | | | 50 |
| | solution No. 5 | | | | | | | |
| | Crosslinking | 33 | 33 | 33 | 33 | | | 33 |
| | agent No. 1 | | | | | | | |
| | Crosslinking | | | | | 33 | 33 | |
| | agent No. 2 | | | | | | | |
| Catalyst | NEOSTANN | 1 | 1 | 1 | 1 | 1 | 1 | 1 |
| | U-100 (Note 6) | | | | | | | |
| Solvent | Solvesso #100 (Note 7) | 130 | 130 | 130 | 130 | 116 | 116 | 130 |

With respect to the proportions of the components, the numerals are expressed in parts by mass (on a solids basis, except for solvents).
(Note 5) BENTONE 38: trade name; a product of Elementis Specialties, Inc., tetraalkyl ammonium hectorite.
(Note 6) NEOSTANN U-100: trade name; a product of Nitto Chemical Industry Co., Ltd., dibutyl tin dilaurate.
(Note 7) Solvesso #100: trade name; a product of Esso Sekiyu K.K., an aromatic hydrocarbon solvent.

### Preparation of Test Plates

Using cold rolled steel sheets (0.8 mm×150 mm×70 mm) treated with zinc phosphating agent Palbond #3020 (trade name; a product of Nihon Parkerizing Co., Ltd.) as substrates, the thermosetting Coating Compositions obtained in Examples and Comparative Examples were applied to the substrates with a bar coater to a film thickness of 20 μm (when dried), and heated and dried at 170° C. for 20 minutes to prepare test plates. Tests were carried out using the obtained test plates. Table 5 shows the test results.

TABLE 5

| | | | | | | | Comparative |
|---|---|---|---|---|---|---|---|
| | Example 1 | Example 2 | Example 3 | Example 4 | Example 5 | Example 6 | Example 1 |
| Thermosetting | No. 1 | No. 2 | No. 3 | No. 4 | No. 5 | No. 6 | No. 7 |
| coating composition | | | | | | | |
| Oxygen | 905 | 859 | 751 | 653 | 520 | 504 | 3500 |
| permeability | | | | | | | |
| coefficient | | | | | | | |
| (cc · μm/m²/day · atm) | | | | | | | |
| (Note 8) | | | | | | | |
| Corrosion resistance (Note 9) | B | B | B | B | B | B | C |

(Note 8) Oxygen permeability coefficient: The thermosetting coating compositions were applied to tin plates with a bar coater and heated and dried at 170° C. for 20 minutes to form a coating film having a thickness of 35 μm when dried. Each coating film (50 × 50 mm) was peeled off by the mercury amalgam process and placed in the cells of an oxygen permeability meter (OXTRAN 2/21, trade name, a product of Mocon, Inc.). Subsequently, the oxygen permeability coefficient (cc · μm/m² · day · atm) of each coating film, calculated as a film with a thickness of 1 μm (at a temperature of 25° C. and a relative humidity of 50%), was determined using the oxygen permeability meter.
(Note 9) Corrosion resistance: The coated surface of each test plate was cross-cut with a knife, so that the cut reached the substrate. Each test plate was then subjected to a salt spray test at 35° C. for 840 hours in accordance with JIS Z 2371. The corrosion resistance was evaluated, based on the width of rust or blister developed in the cut portion, and the condition (blistering) of the coated surface of the non-cut portion according to the following criteria: A: The maximum width of rust or blister on one side of the cut was not more than 2.0 mm. B: The maximum width of rust or blister on one side of the cut was more than 2.0 mm and not more than 3.0 mm. C: The maximum width of rust or blister on one side of the cut was more than 3.0 mm and not more than 3.5 mm. D: The maximum width of rust or blister on one side of the cut was more than 3.5 mm.

### Production Example of Cationic Electrodeposition Coating Composition

### Production Example 11

### Preparation of Emulsion No. 1

87.5 parts (70.0 parts, on a solids basis) of the amino-group-containing modified resin solution No. 1 obtained in Production Example 5, and 33.3 parts (30.0 parts, on a resin solids basis) of the crosslinking agent No. 1 obtained in Production Example 9 were mixed. After 13.0 parts of 10% acetic acid was added and the mixture was uniformly stirred, 192.0 parts of deionized water was added dropwise over a period of about 15 minutes while stirred vigorously. An emulsion No. 1 was thus obtained.

### Production Examples 12 to 16

### Preparation of Emulsions Nos. 2 to 6

Emulsions Nos. 2 to 6 were obtained in the same manner as in Production Examples 11, except for using the components and proportions thereof shown in Table 6.

### Comparative Production Example 5

### Preparation of Emulsion No. 7

An emulsion No. 7 was prepared in the same manner as in Production Example 11, except for using the components and proportions thereof shown in Table 6.

TABLE 6

| | Production | Production | Production | Production | Production | Production | |
|---|---|---|---|---|---|---|---|
| | Example | Example | Example | Example | Example | Example | Comparative |
| | 11 | 12 | 13 | 14 | 15 | 16 | Example 5 |
| Emulsion | No. 1 | No. 2 | No. 3 | No. 4 | No. 5 | No. 6 | No. 7 |
| Amino-group- | 87.5 | | | | 87.5 | | |
| containing | (70.0) | | | | (70.0) | | |
| modified resin | | | | | | | |
| solution No. 1 | | | | | | | |
| Amino-group- | | 87.5 | | | | | |
| containing | | (70.0) | | | | | |
| modified resin | | | | | | | |
| solution No. 2 | | | | | | | |
| Amino-group- | | | 87.5 | | | 87.5 | |
| containing | | | (70.0) | | | (70.0) | |
| modified resin | | | | | | | |
| solution No. 3 | | | | | | | |
| Amino-group- | | | | 87.5 | | | |
| containing | | | | (70.0) | | | |
| modified resin | | | | | | | |
| solution No. 4 | | | | | | | |
| Amino-group- | | | | | | | 87.5 |
| containing | | | | | | | (70.0) |
| modified resin | | | | | | | |
| solution No. 5 | | | | | | | |
| Crosslinking | 33.0 | 33.0 | 33.0 | 33.0 | | | 33.0 |
| agent No. 1 | (30.0) | (30.0) | (30.0) | (30.0) | | | (30.0) |
| Crosslinking | | | | | 33.0 | 33.0 | |
| agent No. 2 | | | | | (30.0) | (30.0) | |
| 10% acetic | 13.0 | 13.0 | 13.0 | 13.0 | 13.0 | 13.0 | 13.0 |
| acid | | | | | | | |
| Deionized | 192.0 | 192.0 | 192.0 | 192.0 | 192.0 | 192.0 | 192.0 |
| water | | | | | | | |
| 32% emulsion | 312.5 | 312.5 | 312.5 | 312.5 | 312.5 | 312.5 | 312.5 |
| | (100.0) | (100.0) | (100.0) | (100.0) | (100.0) | (100.0) | (100.0) |

The numerals indicate the proportions of the components; the numerals in parenthesis indicate the solids contents thereof.

### Production Example 17

### Preparation of Resin for Pigment Dispersion

390 parts of bisphenol A, 240 parts of PLACCEL 212 (trade name, a product of Daicel Chemical Industries, Ltd., polycaprolactone diol, weight average molecular weight: about 1,250), and 0.2 parts of dimethylbenzylamine were added to 1,010 parts of jER82SEL (see Note 2). The mixture was allowed to react at 130° C. to achieve an epoxy equivalent of about 1,090.

Subsequently, 134 parts of dimethylethanolamine and 150 parts of a 90% aqueous lactic acid solution were added, and the mixture was allowed to react at 120° C. for 4 hours. Subsequently, the solids content was adjusted by adding methyl isobutyl ketone. An ammonium salt-type epoxy resin for pigment dispersion having a solids content of 60% was thereby produced.

### Production Example 18

### Preparation of Pigment Dispersion Paste

8.3 parts (5 parts, on a solids basis) of the ammonium salt-type epoxy resin for pigment dispersion having a solids content of 60%, 14.5 parts of titanium oxide, 7.0 parts of refined clay, 0.3 parts of carbon black, 1 part of dioctyltin oxide, 1 part of bismuth hydroxide, and 20.2 parts of deionized water were added and dispersed using a ball mill for 20 hours. A pigment-dispersed paste having a solids content of 55% was thereby produced.

### Example 7

312.5 parts (100.0 parts on a solids basis) of Emulsion No. 1 obtained in Production Example 11, 52.4 parts (28.8 parts on a solids basis) of a 55% pigment-dispersed paste, and 279.1 parts of deionized water were added to produce a cationic electrodeposition coating composition No. 1 having a solids content of 20%.

### Examples 8 to 12

Cationic electrodeposition coating compositions Nos. 2 to 6 were produced in the same manner as in Example 1, except for using the components and proportions thereof shown in Table 7.

### Comparative Example 2

A cationic electrodeposition coating composition No. 2 was produced in the same manner as in Example 1, except for using the components and proportions thereof shown in Table 7.

TABLE 7

| | | | | Example | Example | Example | Comparative |
|---|---|---|---|---|---|---|---|
| | Example 7 | Example 8 | Example 9 | 10 | 11 | 12 | Example 2 |
| Cationic | No. 1 | No. 2 | No. 3 | No.4 | No. 5 | No. 6 | No. 7 |
| electrodeposition | | | | | | | |
| coating | | | | | | | |
| composition | | | | | | | |
| Emulsion No. 1 | 312.5 | | | | | | |
| | (100) | | | | | | |
| Emulsion No. 2 | | 312.5 | | | | | |
| | | (100) | | | | | |
| Emulsion No. 3 | | | 312.5 | | | | |
| | | | (100) | | | | |
| Emulsion No. 4 | | | | 312.5 | | | |
| | | | | (100) | | | |
| Emulsion No. 5 | | | | | 312.5 | | |
| | | | | | (100) | | |
| Emulsion No. 6 | | | | | | 312.5 | |
| | | | | | | (100) | |
| Emulsion No. 7 | | | | | | | 312.5 |
| | | | | | | | (100) |
| Pigment- | 52.4 | 52.4 | 52.4 | 52.4 | 52.4 | 52.4 | 52.4 |
| dispersed paste | (28.8) | (28.8) | (28.8) | (28.8) | (28.8) | (28.8) | (28.8) |
| Deionized water | 279.1 | 279.1 | 279.1 | 279.1 | 279.1 | 279.1 | 279.1 |
| 20% bath | 644 | 644 | 644 | 644 | 644 | 644 | 644 |
| | (128.8) | (128.8) | (128.8) | (128.8) | (128.8) | (128.8) | (128.8) |

The numerals indicate the proportions of the components; the numerals in parenthesis indicate solids contents thereof.

### Preparation of Test Plates

Using cold rolled steel sheets (0.8 mm×150 mm×70 mm) treated with Palbond #3020 (trade name, a product of Nihon Parkerizing Co., Ltd., a zinc phosphating agent) or alloyed hot-dip galvanized steel sheets (0.8 mm×150 mm×70 mm) treated with Palbond #3020 likewise as substrates, the cationic electrodeposition coating compositions obtained in Examples and Comparative Examples were electrodeposited on the substrates to a film thickness of 20 μm (when dried), and heated and dried at 170° C. for 20 minutes to prepare test plates. Tests were carried out using the test plates. Table 8 shows the test results.

TABLE 8

| | | | | Example | Example | Example | Comparative |
|---|---|---|---|---|---|---|---|
| | Example 7 | Example 8 | Example 9 | 10 | 11 | 12 | Example 2 |
| Cationic | No. 1 | No. 2 | No. 3 | No. 4 | No. 5 | No. 6 | No. 7 |
| electrodeposition | | | | | | | |
| coating composition | | | | | | | |
| Oxygen | 655 | 678 | 452 | 416 | 407 | 321 | 2340 |
| permeability | | | | | | | |
| coefficient | | | | | | | |
| (cc · μm/m² · day · atm) | | | | | | | |
| (see Note 8) | | | | | | | |
| Corrosion resistance | B | A | A | A | A | A | B |
| (see Note 9) | | | | | | | |
| Exposure resistance (Note 10) | B | B | B | A | B | A | B |
| Electrodeposition | A | B | A | B | A | B | B |
| coatability on | | | | | | | |
| alloyed hot-dip | | | | | | | |
| galvanized steel | | | | | | | |
| sheets (Note 11) | | | | | | | |
| Finish (Note 12) | A | B | A | B | A | B | B |

(Note 10) Exposure resistance: aqueous intermediate coating composition WP-300 (a product of Kansai Paint Co., Ltd.) was electrodeposited on test plates prepared in the same manner as those prepared for the corrosion resistance test to a film thickness of 25 μm (when cured), and then baked at 140° C. for 30 minutes using an electric hot air dryer. NEO AMILAC 6000 topcoat composition (a product of Kansai Paint Co., Ltd.) was sprayed over the intermediate coating films to a film thickness of 35 μm (when cured), and baked at 140° C. for 30 minutes using an electric hot air dryer to prepare plates for exposure testing. The coated surface of the plates for exposure testing was cross-cut with a knife so that the cut reached the substrate. The plates were placed horizontally and exposed to the atmosphere in Chikura-machi, a costal area in Chiba prefecture, for one year. The exposure resistance was then evaluated, based on the width of rust or blister developed in the cut portion. A: The maximum width of rust or blister on one side of the cut was not more than 2 mm. B: The maximum width of rust or blister on one side of the cut was at least 2.0 mm and not more than 3.0 mm. C: The maximum width of rust or blister on one side of the cut was at least 3.0 mm and not more than 4.0 mm. D: The maximum width of rust or blister on one side of the cut was 4.0 mm or more.
(Note 11) Electrodeposition coatability on alloyed galvanized steel sheets: Alloyed hot-dip galvanized steel plates (0.8 mm × 150 mm × 70 mm) treated with zinc phosphating agent Palbond #3020 (trade name; a product of Nihon Parkerizing Co., Ltd.) were immersed as cathodes into baths (30° C.) of the electrodeposition coating compositions, respectively and a current was applied at 210 V for a suitable time to form an electrodeposition coating film with a thickness of 20 μm. After the obtained coating film was baked at 170° C. for 20 minutes to cure the coating, the number of pinholes in each test piece (10 cm × 10 cm) was counted. A: No pinholes. B: One small pinhole observed, but could be covered with an intermediate coating, and thus was not problematic. C: 2 to 5 pinholes formed. D: 10 or more pinholes formed.
(Note 12) Finish: Cold rolled steel sheets (0.8 × 150 × 70 mm) treated with zinc phosphating agent Palbond #3020 (trade name; a product of Nihon Parkerizing Co., Ltd.) were immersed into the cationic electrodeposition coating compositions to form an electrodeposition coating film. Each electrodeposition coating film was then baked at 170° C. for 20 minutes using a hot air dryer. The surface roughness of the outer portion of each electrodeposited sheet was evaluated from the Ra value determined using Surftest 301 (trade name; a product of Mitutoyo Corporation, a surface roughness measuring instrument). A: The Ra value was less than 0.20; B: The Ra value was at least 0.20 and not more than 0.30. C: The Ra value was at least 0.30 and not more than 0.40. D: The Ra value was more than 0.40.

### INDUSTRIAL APPLICABILITY

The coating composition of the present invention can provide a coated article having excellent corrosion resistance, and particularly excellent resistance to corrosion from exposure.

1. A coating composition comprising a modified epoxy resin (A) and a crosslinking agent (B), wherein said modified epoxy resin (A) contains a benzene diether structure represented by Formula (1) 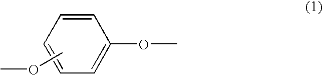
which resin is obtained by reacting diglycidyl ether (a1) with at least one phenol (a2) selected from resorcinol, hydroquinone, and catechol.

2. A coating composition according to claim 1 wherein the modified epoxy resin (A) is an amino-group-containing modified epoxy resin (A1) containing an amino-group-containing compound.

3. A coating composition according to claim 2 wherein the crosslinking agent (B) is a compound having a m-xylylene structure in the molecule.

4. A coating composition according to claim 3 comprising 0.1 to 100 parts by mass of a layered pigment (C) per 100 parts by mass of the total of the modified epoxy resin (A) and the crosslinking agent (B) on a solid basis.

5. A coating composition according to claim 4 which is a cationic electrodeposition coating composition.

6. A coated article produced by applying the coating composition of claim 5.

7. A coating composition according to claim 1 wherein the crosslinking agent (B) is a compound having a m-xylylene structure in the molecule.

8. A coating composition according to claim 7 comprising 0.1 to 100 parts by mass of a layered pigment (C) per 100 parts by mass of the total of the modified epoxyresin (A) and the crosslinking agent (B) on a solid basis.

9. A coating composition according to claim 8 which is a cationic electrodeposition coating composition.

10. A coated article produced by applying the coating composition of claim 9.

11. A coating composition according to claim 1 comprising 0.1 to 100 parts by mass of a layered pigment (C) per 100 parts by mass of the total of the modified epoxy resin (A) and the crosslinking agent (B) on a solid basis.

12. A coating composition according to claim 11 which is a cationic electrodeposition coating composition.

13. A coated article produced by applying the coating composition of claim 12.

14. A coating composition according to claim 2 comprising 0.1 to 100 parts by mass of a layered pigment (C) per 100 parts by mass of the total of the modified epoxy resin (A) and the crosslinking agent (B) on a solid basis.

15. A coating composition according to claim 14 which is a cationic electrodeposition coating composition.

16. A coated article produced by applying the coating composition of claim 15.

17. A coating composition according to claim 1 which is a cationic electrodeposition coating composition.

18. A coated article produced by applying the coating composition of claim 17.

19. A coating composition according to claim 2 which is a cationic electrodeposition coating composition.

20. A coated article produced by applying the coating composition of claim 1.
